(19) United States
(12) Patent Application Publication
(10) Pub. No.: US 2004/0180806 A1
(43) Pub. Date: Sep. 16, 2004

(54) Stabilized foam control compositions, their preparation, and use

(76) Inventors: Hilbert Esselbrugge, Breda (NL); Rob de Bruijn, Numansdorp (NL)

Correspondence Address: David L. Hedden, Ashland Inc., P. O. Box 2219, Columbus, OH, 43216, US

(21) Appl. No.: 10/382,481

(22) Filed: Mar. 6, 2003

(51) Int. Cl. C11D 3/37

(52) U.S. Cl. 510/475

(57) ABSTRACT

The present invention relates to stabilized foam control compositions, their method of preparation, and their use. The stabilized foam control compositions can be used to control foam in a wide variety of processes and products.

### BACKGROUND OF THE INVENTION

1. Field of the Invention

The present invention relates to stabilized foam control compositions, their method of preparation, and their use. The stabilized foam control compositions can be used to control foam in a wide variety of processes and products.

2. Description of the Related Art

Unwanted foam is encountered in a wide variety of processed and products. For example, foaming is often associated with processes that involve polymerization, paint processing and application, fermentation, sugar-refining, oil drilling and refining, food preparation, paper manufacture, sewage disposal, textile dying, printing, adhesive application and conversion of ores refined by flotation. Moreover, liquid coolants, hydraulic fluids, lubricants, and gas adsorption fluids may foam with undesirable results.

There are many ways to eliminate or reduce foaming in a system. Typically, foam can be reduced or eliminated by optimizing the process conditions, using raw materials that have a low tendency for foaming, or, more typically, by adding a foam control agent to the product or at an appropriate step of the process.

If a foam control agent is used, there are two ways to apply the foam control agent. On the one hand, the foam control agent can be used as a process additive in order to suppress the formation of foam. An example of this is the use of foam control agents to control foam during the synthesis of water-based polymer latex dispersions and emulsions. A significant amount of foam, which negatively influences the reaction conditions and the properties of the polymer latex, may be generated during the actual synthesis of the latex dispersion or emulsion and/or during the pumping and drumming of the polymer latex. Thus, it is necessary to add a foam control agent at different steps of the process to control the build up of the foam.

A second way of using foam control agents involves adding the foam control agent as a component of a formulated product, which foams during the production or application of the product. In this case, the foam control agent is one of the many components used for formulating the end product. An example of this use of a foam a control agent is where the foam control agent is added, as an essential component, of a water-based paint or coating. Without a foam control agent, bubbles will form and remain in the paint or coating. When the paint or coating is applied to the substrate, the bubbles wilt dry on the substrate. Apart from the fact that these dried bubbles are not aesthetically pleasing, the substrate is also not well protected from the environment when these bubbles form.

Foam control agents generally are formulated with multiple components, although in some cases the foam control agent may be single liquid or solid. By varying the components of the foam control agent, their weight ratios, and/or by carefully changing the chemical properties of the foam control agent, one can obtain optimal foam control in a specific process or for a specific product.

Because processes and products that produce foam vary greatly and the reasons for foaming are diverse, the inhibition of foam in a particular system often requires a unique solution. Therefore, it has challenged those skilled in the art to develop foam control agents that have multiple uses.

Even if a foam control agent inhibits the formation of foam, there are often unwanted side effects caused by the use of the foam control agent that must be avoided in order for a foam control agent to be useful. The surface active properties of foam control agents may cause film defects, like craters or orange peel, to form when the end-product is used, even when then foam control agent is used in low dosages. This is particularly a problem when the foam control agents is used in water-based coating systems. This problem can be overcome by carefully formulating a foam control agent that will show a high degree of compatibility with the coating system. However, it requires detailed optimization procedures to effectively incorporate the foam control agent into the coating during its production.

All citations referred to under this description of the “Related Art” and in the “Detailed Description of the Invention” are expressly incorporated by reference.

### BRIEF SUMMARY OF THE INVENTION

The present invention relates to stable foam control compositions, their method of preparation, and their use.

The foam control compositions are prepared by combining at least one active foam control agent with at least one active component of an end-use product, and mixing these components with sufficient energy or force to create a mixture that is stable at ambient temperature.

The stable foam control compositions are prepared by subjecting the components of the foam control composition to high energy in a variety of ways. The manner of mixing components is not critical, as long as the resulting mixture is stable. Sufficient stability can be achieved by high-speed mixing, high-shear mixing, homogenization, mixing with equipment having rotor blades, etc., which, in some cases, may require increased pressure or temperature,

The stabilized foam control compositions can be added at appropriate steps during the preparation of the end product and/or to the end product.

The use of the stabilized foam control compositions results in several advantages:

1. The stabilized foam control composition has multiple uses, i.e. is suitable for providing foam control in different end-products.

2. The stabilized foam control composition can be used to inhibit foam during the preparation and/or the use of the end product.

3. A balance between the foam inhibiting activity of the foam control composition and the compatibility of the foam control composition in the end-product can be obtained by optimizing processing conditions during preparation of the end-product.

4. Because the foam control composition is stabilized, a higher dosage of the active foam control agent can be used without encountering miscibility or compatibility problems when dosing and incorporating the foam control composition into the end product.

5. The foam control composition can contain components that are not typically stable when mixed together and could not be used as foam control agents in end-use products. The high energy mixing of the components results in foam control compositions that are stable, and often clear, which could not otherwise be used as foam control compositions.

### Definitions

For purposes of defining this invention, “active foam control agent” means a chemical that is capable of inhibiting foam.

For purposes of this invention, “an end-use-product” is any product that has a tendency to foam if it does not contain a foam control agent, and, thus, requires a “foam control agent” to inhibit or prevent foaming, e.g. a coating, paint, lubricant, metal working fluid, adhesive, ink, overprint varnish, late dispersion, and latex emulsion, etc.

For purposes of this invention, “active component of an end-use-product” means “a component of an end-use-product that is required in the composition of the end-use-product for the end-use-product to function for its intended purpose”.

For purposes of this invention, “foam control composition” is a mixture comprising (a) one or more “active foam control agent”, and (b) “one or more active components of an end-use-product”, such that the weight ratio of (a) to (b) is from about 5:95 to about 80:20, preferably from about 20:80 to about 60:40, depending upon the end-use product. For example, the active foam control agent may be incorporated in one of the active components of an end-use product (e.g. a binder used in formulating a paint), or incorporated into a mixture of less than all of active components of the end-use product, or incorporated in the end-use product itself, (e.g. when formulating a metal working fluids).

For purposes of this invention “high energy” means an amount of energy per unit volume sufficient to produce a stable “foam control composition”. Typically, the amount of energy per unit volume required to produce a stable “foam control composition” is at least 10⁵ J/m³, preferably from 10⁶ to 10⁹J/m³, most preferably from 10⁶ to 10⁸/m³. This corresponds to pressure differences of 10 bars to 1000 bars if a high-pressure homogenizer is used to produce the stabilized foam control agent composition.

For purposes of defining this invention, a “stabilized foam control composition” is mixture of a foam control agent and an end-use product, which does not show full liquid-liquid phase separation or settling or creaming of a solid phase state for at least 1 minute, preferably for at least 30 minutes, most preferably for at least 120 minutes, at ambient temperature as determined by visual observation.

For purposes of this invention, “foam inhibited end-use-product” is an end-use product that contains a “stabilized foam control composition”.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

Any active foam control agent known in the art can be used to prepare the foam compositions of this invention. Typical active foam control agents include silicones, hydrophobic materials, fatty amides, fatty acids or esters, and/or organic polymers. Additional active foam control agents are described in “Foam Control Agents”, by Henry T. Kerner (Noyes Data Corporation, 1976), pages 125-162.

Typical hydrophobic material that car used as the active foam control agent typically have a surface energy of from about 10 to about 40 dynes/cm², preferably from about 20 to about 30 dynes/cm². Preferably the hydrophobic material is precipitated hydrophobic silica or a hydrophobic wax having an average particle size of from 5 to 75 microns, preferably 10 to 15 microns. Precipitated hydrophobic silica is made by treating hydrophilic silica with silicone according to well-known methods. Such precipitated hydrophobic silicon can be purchased from Degussa, Georgia Kaolin, and J. M. Huber.

Typical silicone compounds that can be used as the active foam control agent include polydimethylsiloxanes, often trimethylsilyl terminated. Generally, which are sold commercially as fluids or emulsions (which contain water and a surfactant as well as the silicone compound). Examples of commercially available products, which contain silicone compounds and are effective, include DC 200 sold by Dow Corning Corporation and L-45-350 sold by Union Carbide.

The active foam control agent may be mixed with other components before it is mixed with the active component of the end-use-product. Some of the components that can be mixed with the active foam control agent include, for example, a secondary foam control agent, a carrier, an emulsifier, a stabilizing agent, a surfactant, and/or other materials. Secondary foam control agents modify the crystallinity, surface properties, solubility and roughness of the primary foam control agents.

Typically used as the carrier for the hydrophobic silica and silicone are vegetable oils, e.g. rapeseed oil, canola oil, and soybean oil, preferably soybean oil, particularly refined soybean oil.

The foam control composition may also contain a wax, preferably a hydrophobic waxes include, for example, polyethylene, paraffin wax, ethylene bis stearamide, and the like. These waxes typically have a melting point greater than 100° C., preferably greater than 120° C.

The active component of the end-use-product that is mixed with the active foam control agent will depend upon what end-use is contemplated. For example, if the end-use is a coating, typically the active foam control agent will be mixed with a polymeric binder that is used to formulate the coating. Examples of such polymeric binders or emulsions include polymerized acrylic and/or methacrylic acid, vinyl acrylic, poly (vinyl acetate), styrene, styrene-acrylic copolymers, polyurethane binders, epoxy resins, and alkyd resins, and emulsions or dispersions thereof. Other examples of end-use formulations are summarized as follows:

| End-use product | Active component(s) |
|---|---|
| Emulsions/ | Polymeric binders and dispersions previously listed |
| paints/coatings | and/or styrene-butadieen copolymer lattices, PVC |
| | lattices, nitril-butadieen rubber lattices, polyurethane |
| | binders, epoxy resins, alkyd resins, and/or water with |
| | or without surfactants, and/or water with or without |
| | glycol solvents, and/or solutions of |
| | surfactants/wetting agents. |
| Inks | Polymeric binders and dispersions previously listed |
| | and/or water with or without surfactants, and/or water |
| | with or without glycol solvents, and/or solutions of |
| | surfactants/wetting agents. |
| Adhesives | Polymeric binders and dispersions previously listed, |
| | and/or polyvinylalcohols, and/or water with or |
| | without surfactants, and/or water with or without |
| | glycol solvents, and/or solutions of |
| | surfactants/wetting agents. |
| Food industry | Natural vegetable oils, refined or crude, like soy bean |
| | oil, rape seed oil, coconut oil, castor oil, tallow oil or |
| | purified fatty acids like oleic acid, and lauric acid, |
| | and/or process) water with or without natural |
| | surfactants like proteins or starch, and/or polyglycols. |
| Gas adsorption | Process water, mixtures of water and |
| | butylethanolamine and/or methyldiethanolamine, |
| | and/or polyglycols, e.g. PLURONIC ® PL81 polyol, |
| | and/or hydrocarbons. |

These are merely illustrative and generalized examples. Those skilled in the art will know what formulations to use for various applications.

The foam control compositions are prepared by combining the components of the foam control composition and subjecting them to sufficient high energy to produce a stabilized foam control composition.

The mixture can be stabilized by subjecting the mixture to high energy, e.g. with a blade impeller mixer, Harbil mixer, impingement mixer, high shear mixer, agitator mixer, homogenization (particularly a high pressure homogenizer), colloid mill, microfluidizer, ultrasonic mixing, melt mixer, magnetic mixer, rotary blade mixer, propeller mixer, and combinations thereof. Typically, the amount of energy required to produce a “stabilized “foam control composition” is 10⁵ to 10¹⁰ J/m³, preferably from 10⁶ to 10⁸ J/m³.

The stabilized foam control compositions are mixed in end-use products, e.g. paints, coatings, inks, lubricants, emulsions, etc. in amounts greater than 0.05 part by weight, typically up to 80 parts by weight, based upon the weight of the end-product, most typically 1.0 part by weight to 20 parts by weight. The reason for this broad range is that the amount of stabilized foam control used in the end-use product is that the amount used depends upon the end-use application and the demands of the formulator. Formulators skilled in the art will know what amounts are appropriate for different applications.

Lower amounts of stabilized foam control compositions are used, for example, in clear wood coatings and paints, where the dosage is typically 0.25 to 5.0 weight percent of foam control agent based upon the weight of the end-use product, preferably 0.5 to 2.5 weight. In some sensitive applications, dosage levels of active foam control agents may be as low as 0.05 weight percent (for example in very thin leather coatings).

The end-use products may contain thickeners, wetting agents, nonionic surfactants, pigments, coalescent agents, and many other components. Because of the variety of end-product formulations, it is not practical to discuss these formulations in detail. Furthermore, the particular formulation is not believed to be critical to this invention.

### Abbreviations:

The following are used:

FCA foam control agent.

FCA-1 foam control agent sold under the trade name Byk 022, which is supplied by Byk Chemie, Germany.

FCA-2 foam control agent sold under the trade name Tego Foamex 810, which is supplied by Tego Coating and Ink additives, Germany.

FCA-3 foam control agent sold under the trade name DREWPLUS by Drew Industrial, a division of Ashland Specialty Chemical, a division of Ashland Inc.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated.

EXAMPLE 1

(Preparation of a Stable Foam Control Composition by Shearing Under Pressure)

A stable foam control composition was prepared by first mixing 20 parts of a polyoxypropylene modified siloxane having a branched molecular structure and an average molecular weight of 3000 with 80 parts of an acrylate copolymer by stirring, as is typically done when making a coating. The organic groups chemically bonded to the siloxane backbone and are methyl end-capped. The stirrer was operated at a tip speed of 2.5 m/s for 5 minutes. The acrylate copolymer is a binder that is generally used for the formulation of wood coating systems applied by brushing, rolling or spraying. Due to the composition of the binder, the medium has a strong tendency to build and stabilize foam. The blend was not stable, i.e. it separated into two distinct phases, and would not be useful as a foam control agent, because it would not be compatible in the end-product.

The resulting mixture of the siloxane and the acrylate binder was then homogenized using a high-pressure laboratory homogenizer (LAB 1000) having a maximum flow rate of 10 l/hr, which was supplied by APV, the Netherlands. The homogenizer was operated at 800 bar and the mixture was mixed until the product appeared to be homogeneous and stable.

The homogenized product was stored at 40° C. for two weeks and its stability was measured by visual observation. Visual observation indicated that there was no full phase separation, i.e. the phases had not separated completely.

EXAMPLE 2

(Use of the foam Control Composition of Example 1 as a Foam Control Agent for a Primer and Topcoat Paint)

Six parts of the homogenized foam control composition of Example 1 were added to 94 parts of a coating binder (Neocryl XK-90 copolymer supplied by Avecia/Neoresins in the Netherlands) in order to minimize foaming without negatively affecting the film forming properties of the coating.

The product was stored at 40° C. for two weeks and its stability was measured by visual observation. Visual observation indicated that there was no full phase separation, i.e. the phases had not separated completely.

The mixture of the homogenized foam control composition and binder were then used in a primer and topcoat formulation. After the primer and topcoat were applied to separate substrates, an entrained air test (EAT) and compatibility tests (CT) were carried out as follows:

### DETERMINATION OF COMPATIBILITY VIA THE DRAW DOWN METHOD

Apply the sample over the substrate, using a film applicator.

Check the film for surface defects as craters, orange peel, entrained micro foam, wetting problems or as required by customer.

### DETERMINATION OF ENTRAINED AIR VIA THE APPLICATION METHOD

Foam control activity is evaluated by applying the end-product, in which the foam control composition is dosed, onto a substrate, using a hair/foam roller as follows:

Pour 30-50 mls of the end-product into a roller-bath.

Saturate the used roller with end-product.

Apply the roller over the test chart in reproducible manner (3-8 strokes dependent on substrate size)

Force dry/air dry the film and visually evaluate the amount of entrained air (micro-and/or macro foam)

All samples are visually evaluated. The key for interpreting the EAT and CT are as follows:

0/ Excellent (no surface defects, or entrained air, depending upon the test)
1
2
3
4
5/ Very poor (gross surface defects, or significant amount of entrained air,
depending upon the test)

The results are summarized in Table I and II.

### Comparision Examples A and B (Examples Using a Traditional Foam Control Agent)

FCA-1 and FCA-2 were tested for comparison purposes. The results are summarized in Table I and II.

TABLE 1
(Primer for wood based on acrylate copolymer)

| | Foam | | |
|---|---|---|---|
| Example | Control Agent | EAR | CR |
| A | None | 5 | 0 |
| B | FCA-1 | 1 | 1 |
| 2 | Example 1 | 0 | 0 |

The data in Table I indicate that there was less entrained air and fewer surface defects when the homogenized foam control agent was used instead of FCA- 1.

TABLE II
(Topcoat for wood based on acrylate copolymer)

| | Foam | | |
|---|---|---|---|
| Example | Control Agent | EAR | CR |
| C | None | 4 | 0 |
| D | FCA-2 | 1 | 1 |
| 3 | Example 1 | 0 | 0 |

The data in Table II indicate that there was less entrained air and fewer surface defects when the homogenized foam control agent was used instead of FCA-2.

### EXAMPLE 4

(Preparation of Another Homogenized Foam Control Composition Utilizing Pressure)

Another homogenized foam control composition was prepared by first mixing 20 parts of a regular foam control agent consisting of 87 wt % paraffinic oil, 10 wt % of a hydrophobized, precipitated silica and 3 wt % of a fatty acid modified PEG ester with 80 parts of an acrylate copolymer (Neocryl XK-88 which is manufactured by Avecia Neoresins in the Netherlands) by stirring. The foam control agent is a type that normally is used for formulating paints and coatings, while the acrylate copolymer is a binder that is generally used for the formulation of wood coating systems applied by brushing or spraying. Due to the composition of the binder, the medium has a strong tendency to generate foam upon use. This mixture of the foam control agent and the acrylate binder subsequently was then homogenized under re-circulation at 400 bar using a high pressure homogenizer (LAB 1000) having a maximum flow rate of 10 l/hr, which was supplied by APV, the Netherlands, for 5 minutes to produce a stable mixture.

The product was stored (under what conditions) for (what length of time) and its stability was measured by (what method). The stability test indicated that the state of the product was one phase, i.e. there was no phase separation.

### EXAMPLE 5

(Preparation of a White Pigmented Lacquer Using Foam Control Composition of Example 4 and NEOCRYL XK-88)

Five parts of the homogenized foam control composition of Example 4 were added to 95 parts of NEOCRYL XK-88, so that the foaming tendency of the binder was strongly minimized without negatively affecting the film forming properties.

The product was stored (under what conditions) for (what length of time) and its stability was measured by (what method). The stability test indicated that the state of the product was one phase, i.e. there was no phase separation. The unhomogenized mixture was not stable.

TABLE III
(White pigmented, decorative lacquer based on Neocryl XK-88)

| | Foam | | |
|---|---|---|---|
| Example | Control Agent | EAR | CP |
| | None | 4 | 0 |
| | FCA-3 | 1 | 3 |
| 6 | Example 4 | 1 | 0 |

In Table III, the amount of residual air and the compatibility of 30 um (wft) on glass are given after roll application and drying of a white pigmented, decorative lacquer. As the data in Table III indicate, no surface defects like orange peel or craters were observed after complete drying of the applied coating. This was a significant improvement compared to the properties of the existing lacquer system that was formulated and produced using a formulated foam control composition that was added during the manufacturing of the lacquer.

EXAMPLE 7

(Preparation of Homogenized Foam Control Compositions Using Styrene-Acrylic Emulsions)

The foam control compositions of this example were made from a series of water-based styrene-acrylic emulsions, designated as types I to III (respectively sold under the trade names Neocryl XK-88, Neocryl XK-95 and Neocryl XK-98 emulsions respectively, which are supplied by Avecia Neoresins in the Netherlands) and an active foam control agent. These emulsions are generally used for formulating wood lacquers, but strong foam build is observed during use, when the emulsions are stirred and pumped. The foam build up was so severe that drumming of the emulsions was not possible. Therefore, there was a need for a foam control agent that would not only reduce foam to a sufficiently low level, but would be easy to incorporate in the various binders using low shear forces.

A homogenized foam control composition was first prepared by mixing 40 parts of a 50/50 blend of a polypropyleneoxide and a polyethylene-polypropyleneoxide modified siloxane with 60 parts of a styrene-acrylic emulsion (Types I-III) by use of a stirrer generally used in the coating industry. This mixture was then homogenized at 400 bar using a high pressure homogenizer (LAB 1000) having a maximum flow rate of 10 l/hr, which was supplied by APV, the Netherlands.

### EXAMPLE 8

(Use of the Homogenized Foam Control Agent of Example 7 in a Binder in the Preparation of Styrene-Acrylic Binders)

As the Type I to Type III styrene-acrylic emulsions were being manufactured, at an appropriate moment during, 0.08 wt % of the homogenized mixture of Example 7 was charged to the production vessel, resulting in a strong and nearly immediate reduction of the foam. The test results are summarized in Table IV.

TABLE IV
(Use of foam control composition of Example 7 in water-based
styrene-acrylic emulsions I, II and III upon drumming)

| | | Emulsion I | | Emulsion II | | Emulsion III | |
|---|---|---|---|---|---|---|---|
| Example | FCA (dosage) | ERA | CP | EAR | CP | EAR | CP |
| | None | 60 | 0 | 41 | 0 | 29 | 0 |
| | Silicone (0.03) | 25 | 3 | 15 | 3 | 20 | 4 |
| 8 | Example 7 (0.08) | 20 | 1 | 15 | 1 | 15 | 0 |

No surface defects were observed when preparing a 30 μm (wft) draw-downs on glass. When directly dosing the 50/50 w/w blend of the organically modified silicones to a reaction mixture, both the ease of incorporation and the defoaming effect are strongly reduced. In Table IV, the amount of incorporated air and the compatibility of 30 μm (wft) are listed. After incorporation, no surface defects or orange peel should be observed when preparing a 30 μm (wft) draw-down on glass.

We claim:

1. A process for preparing a foam control composition comprising:
(a) combining a mixture of components comprising:
component (a) which comprises one or more active foam control agents; and
component (b) which comprises one or more active components of an end-use product,
such that the weight ratio of (a) to (b) is from about 5:95 to about 80:20; and
(b) mixing (a) and (b) with sufficient energy to create a mixture, which does not show full liquid-liquid phase separation or solid phase separation as determined by visual observation for at least 1 minute after mixing at ambient temperature.

2. The process of claim 1 wherein the amount of energy used to mix (a) and (b) is from about 10⁵ J/m³ to about 10⁹ J/m³.

3. The process of claim 2 wherein the mixing of (a) and (b) is carried out by a high pressure homogenizer or a rotor-stator mixer.

4. The process of claim 2 wherein the active component of an end-use product is a polymeric binder.

5. The process of claim 3 wherein the active component of an end-use product is a polymeric binder, emulsion of polymeric binder, or a dispersion of a polymeric binder.

6. The process of claim 4 wherein the active component of an end-use product is a polymeric binder selected from the group consisting of acrylic polymers, vinyl acrylic polymers, poly(vinyl acetate), styrene polymers, styrene-acrylic copolymers, methacrylic polymers, polyurethane binders, epoxy resins, alkyd resins, and mixtures thereof.

7. The process of claim 5 wherein the active component of an end-use product is a polymeric binder selected from the group consisting of acrylic polymers, vinyl acrylic polymers, poly(vinyl acetate), styrene polymers, styrene-acrylic copolymers, methacrylic polymers, polyurethane binders, epoxy resins, alkyd resins, and mixtures thereof.

8. The process of claim 6 wherein the amount of chemical binder in the foam control composition is from 20 to 95 weight percent based upon the weight of the foam control composition.

9. The process of claim 7 wherein the amount of chemical binder in the foam control composition is from 20 to 95 weight percent based upon the weight of the foam control composition.

10. The process of claim 2 wherein the active components of an end-use product comprise the components of a metal working fluid.

11. The process of claim 3 wherein the active components of an end-use product comprise the components of a metal working fluid.

12. The process of claim 10 wherein the metal working fluid comprises a lubricating oils, polyglycols, a fatty acid modified polyglycols, a mineral oil, a fatty acid, and/or a surfactant.

13. The process of claim 11 wherein the metal working fluid comprises lubricating oils, polyglycols, a fatty acid modified polyglycols, a mineral oil, a fatty acid, and/or a surfactant.

14. A foam control composition prepared by the process of claim 1, 2, 3, 4, 5, 6, 7, 8, 9, 10, 11, 12, or 13.

15. A foam inhibited end-use product that is stabilized against foam formation comprising:
(a) an end-use-product; and
(b) the foam control composition of claim 14.
